(19) United States
(12) Patent Application Publication
(10) Pub. No.: US 2006/0148644 A1
(43) Pub. Date: Jul. 6, 2006

(54) Exhaust gas control catalyst and manufacturing method thereof

(75) Inventor: Kotaro Hayashi, Mishima-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/559,873

(22) PCT Filed: Apr. 21, 2005
(86) PCT No.: PCT/IB05/01055

§ 371 Date: Dec. 7, 2005

(30) Foreign Application Priority Data
Apr. 22, 2004 (JP) 2004126956

(51) Int. Cl. B01J 23/40

(52) U.S. Cl. 502/325

(57) ABSTRACT

A catalyst which can maintain a concentration of a NOₓ, storage material in a catalyst supporting layer at an appropriate value is provided. There is provided an exhaust gas control catalyst including a base material; a catalyst supporting layer which is formed on a surface of the base material and which supports noble metal and a NOₓ, storage material; and a lower layer which is formed at a portion that is in the base material and that is below the catalyst supporting layer, and which supports a NOₓ storage material. A concentration of the NOₓ, storage material supported by the lower layer is higher than a concentration of the NOₓ storage material which is supported by the catalyst supporting layer. Also, a manufacturing method of the exhaust gas control catalyst is provided.

### BACKGROUND OF THE INVENTION

1. Field of the Invention

The invention relates to an exhaust gas control catalyst for purifying components contained in exhaust gas released from a combustion engine, for example, an internal combustion engine.

2. Description of the Related Art

Exhaust gas released from an internal combustion engine, for example, an automobile engine contains nitrogen oxide (NOₓ), carbon monoxide (CO), hydrocarbon (HC), and the like. Usually, the exhaust gas is released into the atmosphere after these components are removed by an exhaust gas control catalyst which oxidizes CO and HC and reduces NOₓ. As an exhaust gas control catalyst, a NOₓ storage reduction catalyst is known in which noble metal and a NOₓ storage material are supported by a carrier formed of porous metal oxide, for example, γ-alumina. Examples of the noble metal are platinum (Pt), rhodium (Rh), and palladium (Pd). Examples of the NOₓ storage material are lithium, potassium, and barium.

When the NOₓ storage reduction catalyst is used, usually, exhaust gas containing excessive amount of oxygen (i.e., lean exhaust gas) is circulated and then the NOₓ storage material stores NOₓ, and CO and HC are oxidized by a catalytic action of the noble metal. Then, control is performed such that the exhaust gas contains excessive amount of fuel intermittently (i.e., rich spike control is performed), whereby the NOₓ stored in the NOₓ storage material is reduced.

Various proposals have been made concerning a method of arranging catalytic components such as noble metal and a NOₓ storage material in a base material. For example, Japanese Patent Application Publication No. JP(A) 2003-245560 discloses a method in which noble metal, for example, platinum, and a NOₓ storage material, for example, potassium and barium are supported by a catalytic carrier coated on a surface of an air hole formed in a cell wall and on a surface of the cell wall. With this catalytic carrier structure, it is possible to obtain an exhaust gas control catalyst which can realize a small pressure loss of the exhaust gas, which has a high exhaust gas purifying ability, and which has high durability.

Each of Japanese Patent Application Publication No. JP(A) 2002-95968 and Japanese Patent Application Publication No. JP(A) 2003-260353 discloses a method in which a membrane made of an oxide, which does not react with alkali metal easily, or a membrane made of alumina, is interposed between a catalyst supporting layer supporting a NOₓ storage material and a base material, when the NOₓ storage material made of alkali metal is used. According to this method, it is possible to prevent the situation in which the alkali metal moves to the base material while the catalyst is used and therefore the base material deteriorates due to a reaction of the alkali metal and a silicon oxide component, for example, cordierite contained in the base material.

Japanese Patent Application Publication No. JP(A) 2003-220342 discloses an exhaust gas control filter of a wall flow type, in which a catalytic component is supported in an air hole formed in a partition of a cell.

The NOₓ storage materials used in the above-mentioned documents, that are, NOₓ storage elements such as alkali metal and alkali earth metal, and compounds such as nitrite and carbonate have a relatively low fusing point, and have high solubility in some cases. Accordingly, even in a relatively early stage of the catalyst use, the NOₓ storage material tends to move to the air-hole and the like of the base material.

In Japanese Patent Application Publication No. JP(A) 2002-95968 and Japanese Patent Application Publication No. JP(A) 2003-260353, attention is focused on a problem that movement of the alkali metal or the like causes deterioration of the base material in the long run, and this problem is solved. However, the movement of the alkali metal or the like causes a decrease in a concentration of the NOₓ storage material in the catalyst supporting layer, particularly, in an area near a surface of the catalyst supporting layer, which mainly contacts an exhaust gas flow. The activity of the NOₓ storage material is realized sufficiently if the NOₓ storage material is arranged near the noble metal. Therefore, the activity of the NOₓ catalyst, which has been moved from the catalyst supporting layer to the base material, cannot be realized sufficiently.

In order to solve this problem, the high concentration of NOₓ storage material may be supported by the catalyst supporting layer in advance in consideration of the movement of the NOₓ storage material. However, an excessively high concentration of the NOₓ storage material may decrease the activity of the noble metal, for example, platinum, that is supported by the catalyst supporting layer along with the NOₓ storage material. Therefore, a NOₓ storage reduction catalyst has been required which can maintain the concentration of the NOₓ storage reduction material in the catalyst supporting layer at an appropriate value.

### SUMMARY OF THE INVENTION

It is an object of the invention to provide an exhaust gas control catalyst that can solve the above-mentioned problems. The exhaust gas control catalyst includes a base material; a catalyst supporting layer (an upper layer) which is formed on a surface of the base material and which supports noble metal and a NOₓ storage material; and a lower layer which is formed at a portion that is in the base material and that is below the catalyst supporting layer and which supports a NOₓ storage material. At a portion where the catalyst supporting layer and the lower layer contact each other, a concentration of the NOₓ storage material supported by the lower layer is higher than a concentration of the NOₓ storage material which is supported by the catalyst supporting layer. Preferably, the concentration of the NOₓ storage material supported by the lower layer is higher than the concentration of the NOₓ storage material which is supported by the catalyst supporting layer by 10 wt % or more. More preferably, the concentration of the NOₓ storage material supported by the lower layer is higher than the concentration of the NOₓ storage material which is supported by the catalyst supporting layer by 50 wt % or more. Further more preferably, the concentration of the NOₓ storage material supported by the lower layer is higher than the concentration of the NOₓ storage material which is supported by the catalyst supporting layer by 100 wt % or more.

In this specification, a “concentration of the NOₓ storage material” indicates an amount of NOₓ storage material per unit water absorption amount of each of the lower layer and the catalyst supporting layer. Also, the NOₓ storage material is an element which is selected from a group consisting of alkali metal, alkali earth metal and rare earth. Preferably, the NOₓ storage material is an element which is selected from a group consisting of alkali metal and alkali earth metal. Further preferably, the NOₓ storage material is an element selected from alkali metal, or a compound formed of alkali metal and alkali earth metal, for example, a compound formed of K, Ca and Ba. The “lower layer” is a portion which is in the base material and which supports the NOₓ storage material. The lower layer may be a portion having a predetermined thickness in the base material, or may be formed in the entire portion of the base material. Further, the “lower layer” may be formed integrally with the other portion of the base material, or may be formed independently of the other portion.

With the exhaust gas control catalyst according to the invention, it is possible to prevent the situation in which the NOₓ storage material in the catalyst supporting layer diffuses while the catalyst is used and therefore the concentration of the NOₓ storage material in the catalyst supporting layer decreases, that is, the situation in which the NOₓ storage ability is decreased in the catalyst supporting layer which mainly contacts the exhaust gas.

A manufacturing method of an exhaust gas control catalyst according to the invention relates to a manufacturing method of an exhaust gas control catalyst which includes a base material; a catalyst supporting layer which is formed on a surface of the base material and which supports noble metal and a NOₓ storage material; and a lower layer which is formed at a portion that is in the base material and that is below the catalyst supporting layer and which supports a NOₓ storage material. The catalyst supporting layer is formed on a surface of the lower layer which supports the NOₓ storage material in advance.

According to the manufacturing method of the exhaust gas control catalyst in the invention, it is possible to prevent the situation in which the NOₓ storage material in the catalyst supporting layer diffuses in the base material while the catalyst is used and therefore the concentration of the NOₓ storage material in the catalyst supporting layer decreases, that is, the situation in which the NOₓ storage ability is decreased in the catalyst supporting layer which mainly contacts the exhaust gas.

In this manufacturing method, preferably, a concentration of the NOₓ storage material supported by the lower layer is higher than a concentration of the NOₓ storage material which is supported by the catalyst supporting layer.

It is to be understood that “storage” used herein means retention of a substance (solid, liquid, gas molecules) in the form of at least one of adsorption, adhesion, absorption, trapping, occlusion, and others.

### BRIEF DESCRIPTION OF THE DRAWINGS

The above-mentioned embodiment and other embodiments, objects, features, advantages, technical and industrial significance of this invention will be better understood by reading the following detailed description of the exemplary embodiments of the invention, when considered in connection with the accompanying drawings, in which:

FIGS. 1A and 1B are sectional side views each of which indicates an exhaust gas control catalyst according to the invention, and graphs each of which indicates a relationship between a distance from a surface of the catalyst in the sectional side view and a concentration of a NOₓ storage material;

FIGS. 2A and 2B are sectional side views each of which indicates an exhaust gas control catalyst in a related art, and graphs each of which indicates a relationship between a distance from a surface of the catalyst in the sectional side view and a concentration of a NOₓ storage material; and

FIG. 3 is a graph showing a NOₓ reduction rate of each of the catalyst according to the invention and the catalyst in the related art.

### DESCRIPTION OF THE EXEMPLARY EMBODIMENTS

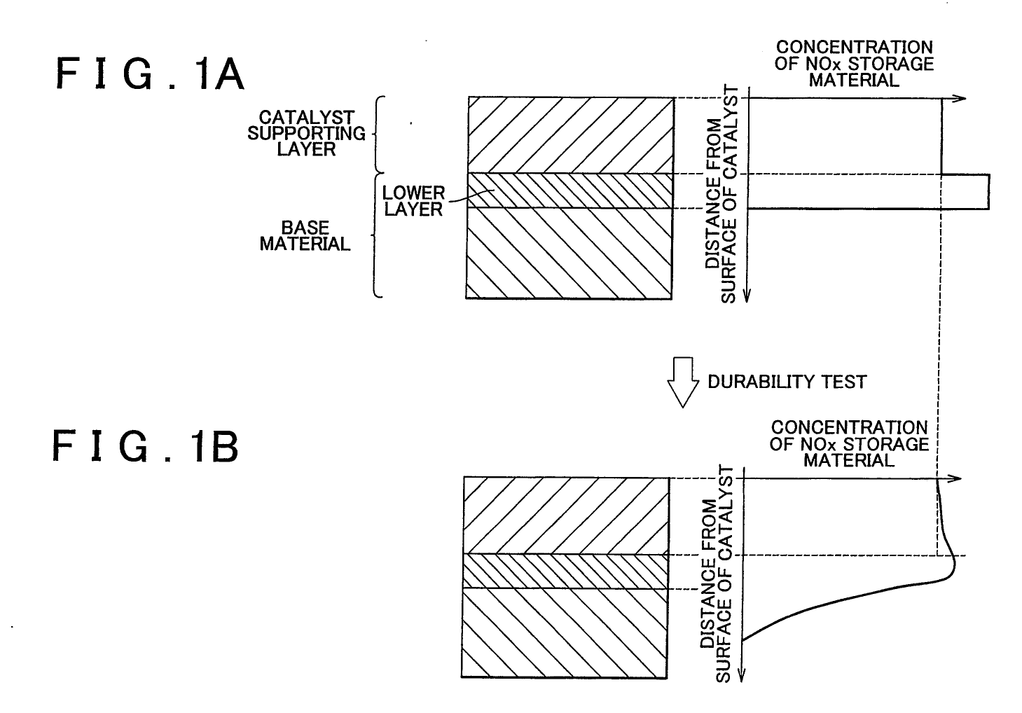

An exhaust gas control catalyst according to the invention will be described with reference to FIG. 1. Note that FIG. 1 is used to conceptually describe the exhaust gas control catalyst according to the invention, and the invention is not limited to the exhaust gas control catalyst shown in FIG. 1.

FIG. 1A is a sectional side view showing the exhaust gas control catalyst according to the invention before a durability test is performed. FIG. 1B is a sectional side view showing the exhaust gas control catalyst according to the invention after the durability test is performed. On the right side of each sectional side view, there is a graph showing a relationship between a distance from a surface of the catalyst shown in the sectional side view and a concentration of the NOₓ storage material.

As shown in the sectional side view in each of FIGS. 1A and 1B, the NOₓ storage reduction catalyst according to the invention includes a catalyst supporting layer and a base material located below the catalyst supporting layer. The catalyst supporting layer supports noble metal and a NOₓ storage material. A lower layer supporting a NOₓ storage material is located in the base material at a surface portion. As shown in FIG. 1A, in the catalyst before being used or before a durability test is performed, the concentration of the NOₓ storage material in the surface portion of the base material, that is, in the lower portion is higher than the concentration of the NOₓ storage material in a bottom portion of the catalyst supporting layer.

As shown in FIG. A, the lower layer located below the catalyst supporting layer supports the high concentration of NOₓ storage material. Therefore, even if the NOₓ storage material moves due to the use of the catalyst at a high temperature, as shown in FIG. 1B, the NOₓ storage material moves from the lower layer. It is therefore possible to maintain the concentration of the NOₓ storage material in the catalyst supporting layer.

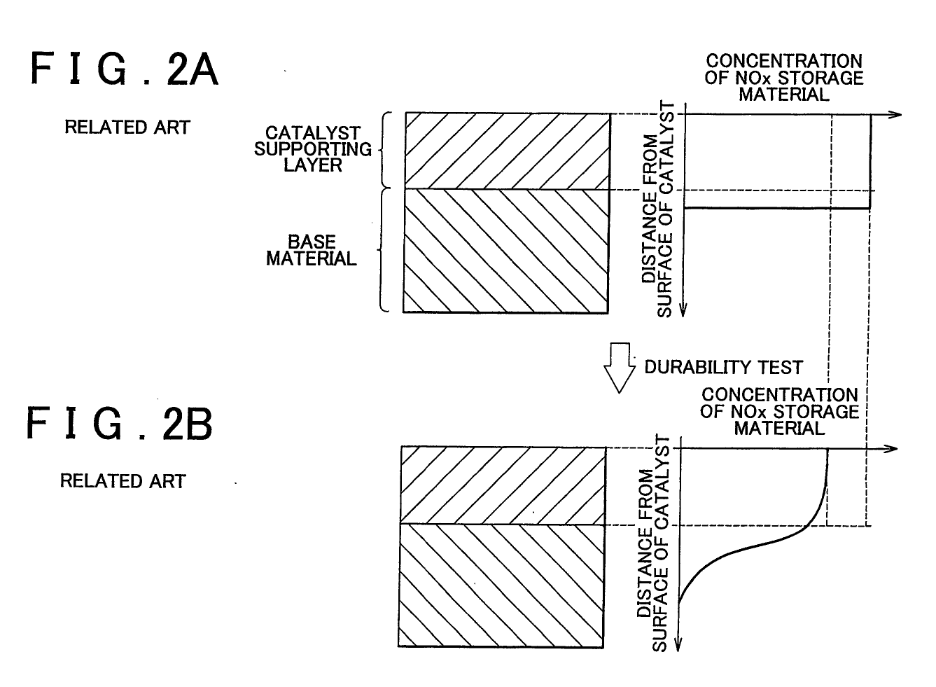

In contrast to this, in an exhaust gas control catalyst in a related art shown in FIGS. 2A and 2B, before the catalyst is used or before a durability test is performed, a concentration of a NOₓ storage material supported by a base material at a surface portion is substantially equal to a concentration of a NOₓ storage material in a bottom portion of a catalyst supporting layer, as shown in FIG. 2A. In this case, if the catalyst is used at a high temperature and therefore the NOₓ storage material moves, the NOₓ storage material moves from the catalyst supporting layer, as shown in FIG. 2B which decreases the concentration of the NOₓ storage material in the catalyst supporting layer.

A manufacturing method of an exhaust gas control catalyst according to the invention is characterized in that, a catalyst supporting layer is formed on a surface of a lower layer which supports a NOₓ storage material in advance, particularly, a coating of a porous material for forming the catalyst supporting layer is applied on the surface of the lower layer, and noble metal and a NOₓ storage material are supported by the coating portion. In contrast to this, in a manufacturing method of an the exhaust gas control catalyst in the related art, a coating of a porous material for forming the catalyst supporting layer is applied on a base material which does not support a NOₓ storage material, and noble metal and a NOₓ storage material are supported by the coating portion. Namely, the manufacturing method of the exhaust gas control catalyst according to the invention is different from the manufacturing method of the exhaust gas control catalyst in the related art in that the NOₓ storage material is supported by the base material before the catalyst supporting layer is formed.

As in the case of the manufacturing method of the exhaust gas control catalyst in the related art, in the case where the NOₓ storage material is supported by the base material after the catalyst supporting layer is formed by coating, the concentration of the NOₓ storage material supported by the base material located below the catalyst supporting layer becomes equal to or lower than the concentration of the NOₓ storage material supported by the catalyst supporting layer. Further, there may be a case where the base material supports substantially no NOₓ storage material. In contrast to this, as in the case of the manufacturing method of the exhaust gas control catalyst according to the invention, in the case where the NOₓ storage material is supported by the base material in advance and the lower layer containing the NOₓ storage material is formed, the concentration of the NOₓ storage material supported by the lower layer located below the catalyst supporting layer can be made higher than the concentration of the NOₓ storage material in the bottom portion of the catalyst supporting layer, and/or an appropriate amount of NOₓ storage material can be supported by the lower layer.

The base material used in the invention may be a commonly used ceramic base material, for example, a cordierite honeycomb.

When a main portion of the base material and the other portion of the base material, which supports the NOₓ storage material thereby forming the lower layer, are made of different materials, the lower layer may be made of materials such as alumina, zirconia, titania, yttria, silica, and ceria. The lower layer is obtained, for example, in a method in which slurry is prepared by mixing powder of these materials with a binder, for example, sol; a ceramic or metal honeycomb material is immersed in the slurry, and then the ceramic or metal honeycomb material is dried and baked. In this case, the lower layer may be baked at a temperature of approximately 350° C., which is a value commonly employed when the catalyst supporting layer is baked. However, it is not necessary to form the lower layer such that the lower layer serves as a catalyst layer. Accordingly, the lower layer may be baked at a higher temperature so as to be formed as a more compact layer. Also, the lower layer may be obtained by accumulating hydroxides on the surface of the base material by using metallic salt, and baking the accumulated hydroxides. The lower layer may be obtained according to the PVD method or the CVD method. The lower layer may be a layer disclosed in Japanese Patent Application Publication No. JP(A) 2002-95968 and Japanese Patent Application Publication No. JP(A) 2003-260353.

The NOₓ storage material may be supported by the lower layer according to a known method. For example, the NOₓ storage material may be supported by the lower layer in a method in which the base material is impregnated with a salt solution, for example, a patassium nitrate solution, and the base material impregnated with the salt solution is dried and baked. Also, the lower layer may be formed of particles supporting the NOₓ storage material in advance. An amount of NOₓ storage material supported by the lower layer may be an arbitrary value. Preferably, the concentration of the NOₓ storage material supported by the lower layer is higher than the concentration of the NOₓ storage material which is supported by the catalyst supporting layer by 10 wt % or more. More preferably, the concentration of the NOₓ storage material supported by the lower layer is higher than the concentration of the NOₓ storage material which is supported by the catalyst supporting layer by 50 wt % or more. Further more preferably, the concentration of the NOₓ storage material supported by the lower layer is higher than the concentration of the NOₓ storage material which is supported by the catalyst supporting layer by 100 wt % or more.

Also, the amount of NOₓ storage material supported by the lower layer may be decided based on a water absorption rate of the lower layer and/or pore volume formed in the lower layer. For example, the amount of NOₓ storage material supported by the lower layer may be decided such that the pores are filled with the NOₓ storage material. In the case of a monolith carrier, a water absorption rate (the weight of water which can be absorbed/the weight of the base material) is 15%, and pore volume is 0.15 to 0.25 cm³/g. In the case of a diesel particulate filter, a water absorption rate is 55%, and pore volume is 0.75 cm³/g.

The catalyst supporting layer may be formed of a known material used for a three-way catalyst, a NOₓ storage reduction catalyst, and the like. The catalyst supporting may be made of materials such as alumina, zirconia, titania, yttria, silica, and ceria. The catalyst supporting layer is obtained, for example, in a method in which slurry is prepared by mixing powder of these materials with a binder, for example, sol; the base material is immersed in the slurry; and then the base material is dried and baked. The catalyst supporting layer may be baked at a temperature of approximately 350° C., which is a value commonly employed when the catalyst supporting layer is baked.

The noble metal supported by the catalyst supporting layer is, for example, platinum (Pt), rhodium (Rh), and/or palladium (Pd). The noble metal may be supported by the catalyst supporting layer according to a commonly employed method. For example, the noble metal may be supported by the catalyst supporting layer according to a method in which the catalyst supporting layer is impregnated with a noble metal salt solution, for example, a dinitrodiammine platinum solution and/or a rhodium nitrate solution; and then the catalyst supporting layer impregnated with the noble metal salt solution is dried and baked. An amount of noble metal supported by the catalyst supporting layer may be a value which is commonly employed in an exhaust gas control catalyst. Preferably, the amount of noble metal supported by the catalyst supporting layer is 1 to 5 gram(s) per one liter of base material. More preferably, the amount of noble metal supported by the catalyst supporting layer is 1 to 2 gram(s) per one liter of base material.

The NOₓ storage material may be supported by the catalyst supporting layer according to a known method. For example, the NOₓ storage material may be supported by the catalyst supporting layer according to a method in which the catalyst supporting layer is impregnated with a salt solution, for example, a potassium nitrate solution, and the catalyst supporting layer impregnated with the salt solution is dried and baked. An amount of NOₓ storage material supported by the catalyst supporting layer may be an arbitrary value. For example, the amount of NOₓ storage material supported by the catalyst supporting layer may be 0.01 to 1.0 mol per one liter of base material. If the concentration of the NOₓ storage material supported by the catalyst supporting layer is excessively high, the catalytic activity of the noble metal may be decreased. On the other hand, if the concentration of the NOₓ storage material is excessively low, the NOₓ storage ability of the catalyst becomes insufficient.

Hereafter, an embodiment of the invention will be described. Note that the invention is not limited to the following embodiment.

The embodiment will be described. A honeycomb material made of cordierite (2MgO.2A₂O₃.5SiO₂) was impregnated with a predetermined amount of potassium nitrate solution having a predetermined concentration, and then dried for 20 minutes at a temperature of 250° C. Then, the honeycomb material impregnated with the potassium nitrate solution was baked for 30 minutes at a temperature of 500° C. such that potassium was supported by the base material, whereby the lower layer was formed. The amount of potassium supported by the base material was 0.3 mol per one liter of base material. Then, the catalyst supporting layer was formed in a method in which a wash coating of slurry whose main component was alumina powder was applied to the base material, and the coating portion was dried at a temperature of 250° C. and then baked for two hours at a temperature of 350° C. The amount of catalyst supporting layer was 180 grams per one liter of base material.

Then, Pt was supported by the catalyst supporting layer in a method in which the base material having the catalyst supporting layer was immersed in a dinitrodiammine platinum nitric acid solution, taken out from the solution, and baked for two hours at a temperature of 350° C. The amount of Pt supported by the catalyst supporting layer was 1 gram per one liter of base material. Next, potassium was supported by the base material in a method in which the base material was impregnated with a predetermined amount of patassium nitrate solution having a predetermined concentration, dried for 20 minutes at a temperature of 250° C., and baked for two hours at a temperature of 350° C. The amount of potassium supported by the base material was 0.3 mol per one liter of base material. The thus obtained catalyst is the catalyst in the embodiment.

Next, a comparative example will be described. A catalyst in the comparative example was obtained in the same method as in the embodiment except that potassium was not supported by the base material before a coating of the catalyst supporting layer was applied to a honeycomb base material.

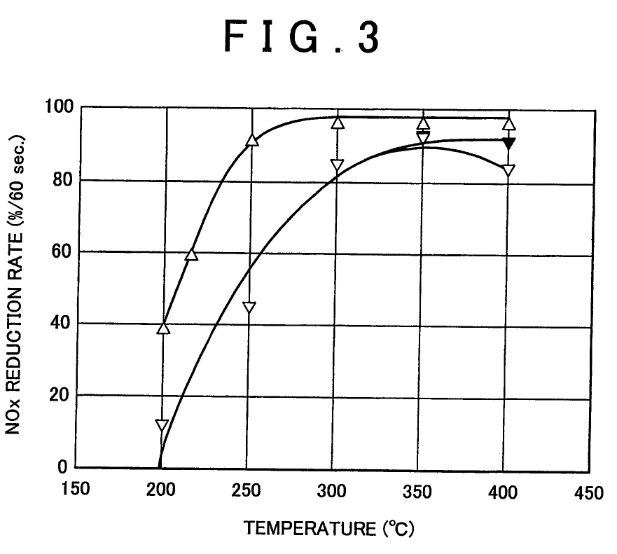

A durability test for each of the catalyst in the embodiment and the catalyst in the comparative example was performed for 50 hours at a temperature of 650° C. While the durability test was performed, a rich gas and a lean gas, each of which containes components shown in a table 1, were alternatively circulated every five minutes. After the durability test was finished, the lean gas was circulated in the catalyst such that the catalyst stores NOₓ, the rich gas was circulated in the catalyst for 20 seconds, and then the lean gas was circulated in the catalyst, whereby the NOₓ reduction rate during 60 seconds was measured. A space velocity was maintained at 50000/h. The result of the measurement is shown in FIG. 3.

TABLE 1

| | C₃H₆ | CO | NO | CO₂ | H₂O | O₂ | N₂ |
|---|---|---|---|---|---|---|---|
| | (ppm) | (ppm) | (ppm) | (%) | (%) | (%) | (—) |
| Lean | 3000 | 3000 | 250 | 8 | 8 | 6 | Rest |
| Rich | 3000 | 3000 | 250 | 8 | 8 | 0 | Rest |

In the comparative example, the NOₓ reduction rate is decreased in a region in which a temperature is 300° C. or higher. It is considered that the decrease in the NOₓ reduction rate is caused by a decrease of the amount of NOₓ storage material in the catalyst supporting layer. The amount of NOₓ storage material is decreased since the NOₓ storage material moves from a portion near the surface of the catalyst supporting layer to the base material side and the NOₓ storage material is dissolved into the material of the catalyst supporting layer and the base material. In the embodiment of the invention, the NOₓ reduction rate in the region in which a temperature is 300° C. or higher is improved, as compared with the comparative example. It is considered that the appropriate NOₓ reduction rate is obtained since the concentration of the NOₓ storage material in the catalyst supporting layer can be maintained relatively stably.

In a region in which a temperature is 300° C. or lower, there is no difference in the NOₓ reduction rate between the embodiment and the comparative example. It is considered that the NOₓ reduction rate in this region depends not on the concentration of the NOₓ storage material in the catalyst supporting layer but on the activity of platinum. Namely, it is considered that a decrease in the NOₓ reduction rate in this region after the durability test is caused by sintering of platinum.

1. An exhaust gas control catalyst, comprising:
a base material;
a catalyst supporting layer which is formed on a surface of the base material and which supports noble metal and a NOₓ storage material; and
a lower layer which is formed at a portion that is in the base material and that is below the catalyst supporting layer, and which supports a NOₓ storage material, wherein
a concentration of the NOₓ storage material supported by the lower layer is higher than a concentration of the NOₓ storage material which is supported by the catalyst supporting layer.

2. A manufacturing method of an exhaust gas control catalyst, comprising:
forming a layer which supports a NOₓ storage material in advance in a base material at a surface portion; and
forming a catalyst supporting layer which supports noble metal and a NOₓ storage material on a surface of the lower layer.

3. The manufacturing method of the exhaust gas control catalyst according to claim 2, wherein
a concentration of the NOₓ storage material supported by the lower layer is higher than a concentration of the NOₓ storage material which is supported by the catalyst supporting layer.
